(19) United States
(12) Patent Application Publication
(10) Pub. No.: US 2014/0012593 A1
(43) Pub. Date: Jan. 9, 2014

(54) APPARATUDS AND METHOD FOR LIFESTYLE MANAGEMENT BASED ON MODEL

(71) Applicant: Samsung Electronics Co., Ltd., Suwon-si (KR)

(72) Inventor: Hyun-Jun KIM, Osan-si (KR)

(21) Appl. No.: 13/935,640

(22) Filed: Jul. 5, 2013

(30) Foreign Application Priority Data
Jul. 4, 2012 (KR) 10-2012-0073013

(51) Int. Cl. G06F 19/00

(52) U.S. Cl. CPC G06F 19/345
USPC 705/2

(57) ABSTRACT

An apparatus for lifestyle management based on models established from characteristics of individual users. The apparatus includes a collector configured to acquire user data including data acquired by a sensor; a determiner configured to analyze the acquired user data based on a model and determine whether a user has an abnormal condition; and an information provider configured to provide the user with information of the abnormal condition.

### CROSS-REFERENCE TO RELATED APPLICATION(S)

This application claims the benefit under 35 U.S.C. §119(a) of Korean Patent Application No. 10-2012-0073013, filed on Jul. 4, 2012, the entire disclosure of which is incorporated herein by reference for all purposes.

### BACKGROUND

1. Field

The following description relates to an apparatus and method for lifestyle management based on a model established from characteristics of individual users.

2. Description of the Related Art

With the increased attention to health, a variety of remote patient monitoring and examination systems have been proposed in the u-Health field for the purpose of providing health and medical services. Such apparatus and method may enable users to monitor and manage their lifestyle through users' own devices, such as, for example, smart phones and/or tablet personal computers. However, due to technical limitations of sensory devices, low penetration rates, and restrictions in transmission and analysis of acquired data, utilization of such systems by general users has not been realized, and only experts, such as medical practitioners, use such systems.

### SUMMARY

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

In one general aspect, there is provided an apparatus for lifestyle management, the apparatus including: a collector configured to acquire user data including data acquired by a sensor; a determiner configured to analyze the acquired user data based on a model and determine whether a user has an abnormal condition; and an information provider configured to provide the user with information of the abnormal condition.

The model may be created according to criteria including characteristics of individual users or groups of similar users.

The apparatus may further include an updater configured to receive models from a server.

The sensor data may include at least one of user's activities, user's state, user's voice, user's surroundings, user's activity on a touch panel, user's terminal's location, user's terminal's call status, user's software usage history, user's emotional data, and user's biometric data.

The user data may contain information including at least one of user sex, age, occupation, residence, workplace, current illnesses, chronic diseases, smoking habit and drinking habit.

The determiner may be further configured to determine whether the acquired user data is required for a server to learn; and the apparatus may further include a transmitter configured to transmit the acquired user data to the server.

The determiner may be further configured to determine whether to adjust a user data collection interval or a data transmission interval for transmitting data to the server; and the apparatus may further include an interval controller configured to adjust the user data collection interval or the data transmission interval according to predefined criteria.

The apparatus may further include a storage database configured to store models at a terminal.

In another general aspect, there is provided an apparatus for lifestyle management, the apparatus including: a receiver configured to receive user data from terminals; a modeler configured to create one or more models from the received user data and according to predefined criteria including characteristics of individual users or groups of similar users; an analyzer configured to analyze the one or more models and create new information; and a distributor configured to transmit the one or more models or new information to a requesting terminal.

The distributor may be further configured to selectively transmit the one or more models associated with characteristics of a user of the requesting terminal.

The apparatus may further include a model database configured to store the models; and a knowledge information database configured to store new information.

In yet another general aspect, there is provided a method of lifestyle management based on a model, the method including: acquiring user data including sensor data generated by a sensor; analyzing the acquired user data based on a model; determining whether a user has an abnormal condition; and providing the user with information of the abnormal condition.

The model may be created based on criteria including characteristics of individual users or groups of similar users.

The method may further include receiving a newly updated model from a server.

The sensor data may include at least one of a user's activities, user's state, user's voice, user's surroundings, user's activity on a touch panel, user's terminal's location, user's terminal's call status, user's software usage history, user's emotional data, and user's biometric data.

The user data may contain user's information including at least one of sex, age, occupation, residence, workplace, current illnesses, chronic diseases, smoking habit and drinking habit.

The method may further include determining whether the acquired user data is required for the server to learn; and transmitting the acquired user data to the server.

The method may further include determining whether to adjust a user data collection interval or a data transmission interval for transmitting data to the server; and adjusting the user data collection interval or the data transmission interval according to predefined criteria.

In yet another general aspect, there is provided a method of lifestyle management, the method including: receiving data acquired from terminals; creating one or more models from the received user data and according to predefined criteria including characteristics of individual users or groups of similar users; analyzing the one or more models to create new information; and transmitting the one or more models or new information to a requesting terminal.

The transmitting of the model may include selectively transmitting the one or more models associated with characteristics of a user of the requesting terminal to the requesting terminal.

Other features and aspects will be apparent from the following detailed description, the drawings, and the claims.

### BRIEF DESCRIPTION OF THE DRAWINGS

FIG. 1 is a diagram illustrating an example of an apparatus for lifestyle management based on a model.

FIG. 2 is a diagram illustrating examples of user data acquired by sensors.

FIGS. 3A and 3B are diagrams illustrating examples of models based on the user data of FIG. 2.

FIG. 4 is a diagram illustrating an example of an apparatus for lifestyle management based on a model.

FIG. 5 is a diagram illustrating an example of a method of lifestyle management based on a model.

FIG. 6 is a diagram illustrating an example of a method of lifestyle management based on a model.

Throughout the drawings and the detailed description, unless otherwise described, the same drawing reference numerals will be understood to refer to the same elements, features, and structures. The relative size and depiction of these elements may be exaggerated for clarity, illustration, and convenience.

### DETAILED DESCRIPTION

The following description is provided to assist the reader in gaining a comprehensive understanding of the methods, apparatuses, and/or systems described herein. Accordingly, various changes, modifications, and equivalents of the methods, apparatuses, and/or systems described herein will be suggested to those of ordinary skill in the art. In addition, descriptions of well-known functions and constructions may be omitted for increased clarity and conciseness.

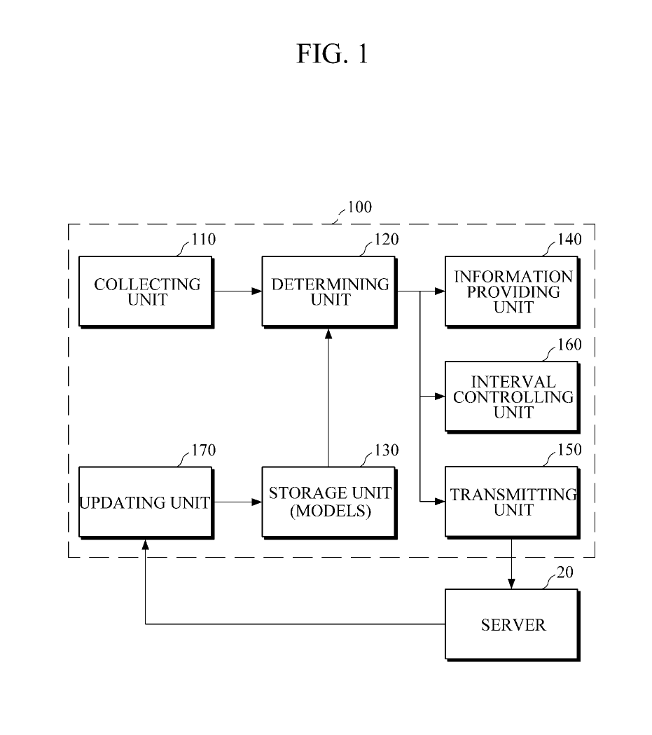

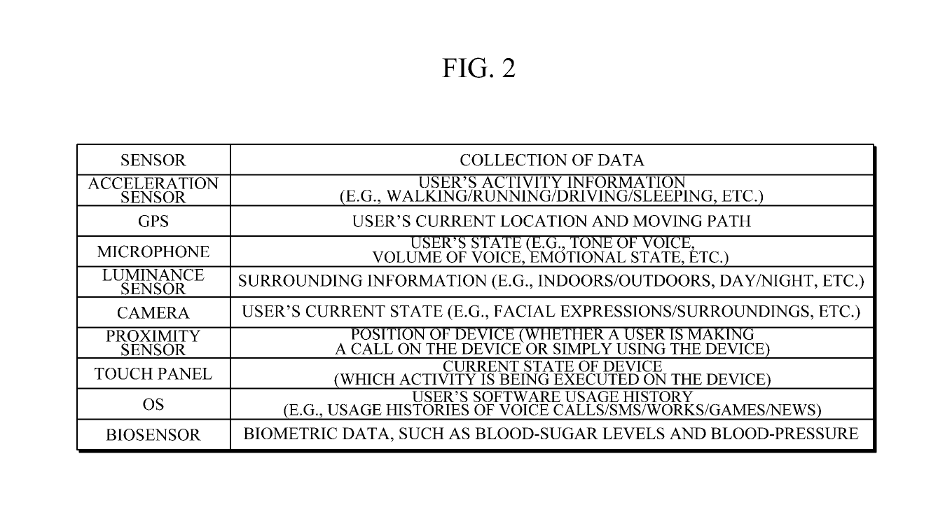

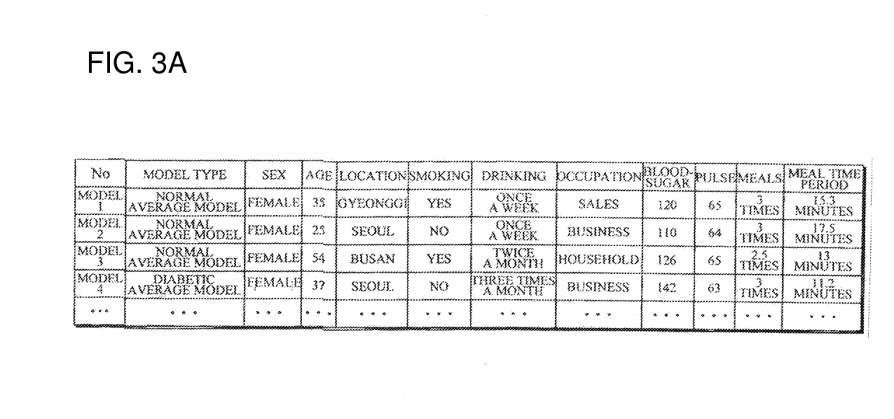

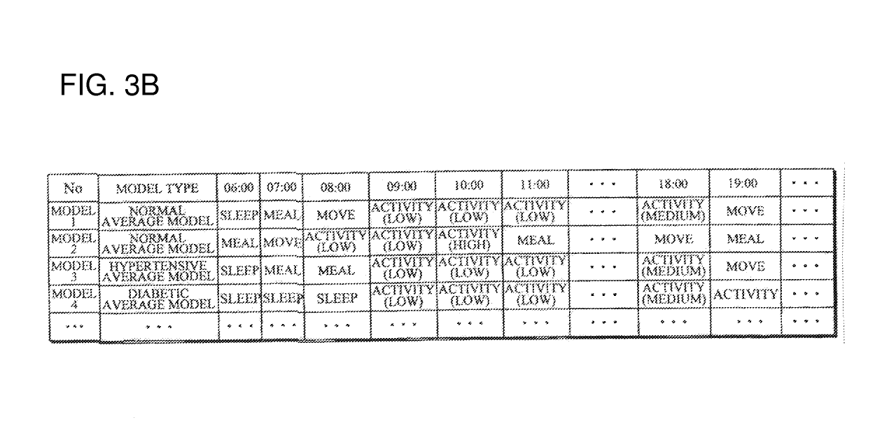

FIG. 1 illustrates an example of an apparatus for lifestyle management based on a model. FIG. 2 illustrates examples of user data that may be acquired by sensors. FIGS. 3A and 3B illustrate examples of models created based on the user data of FIG. 2.

With reference to FIGS. 1 to 3B, the apparatus 100 for lifestyle management based on a model will be described. The apparatus 100 may be installed on a mobile terminal. As a non-exhaustive example only, the terminal or mobile terminal described herein may refer to mobile devices such as, for example, a cellular phone, smart phone, a wearable smart device (such as, for example, a watch, a glass, or the like), a tablet personal computer (PC), a personal digital assistant (PDA), a digital camera, a portable game console, and an MP3 player, a portable/personal multimedia player (PMP), a handheld e-book, a portable lab-top PC, a global positioning system (GPS) navigation, and devices such as a desktop PC, a high definition television (HDTV), an optical disc player, a setup box, and the like capable of wireless communication or network communication consistent with that disclosed herein. The apparatus 100, as shown in FIG. 1, may include a collecting unit 110, a determining unit 120, and an information providing unit 140.

The collecting unit 110 collects physical and emotional user data related to the behavior, life habits, and health of a user of the mobile terminal. The user data acquired by the collecting unit 110 may include information concerning the user and the user's lifestyle, such as, for example, the sex, age, occupation, residence, workplace, current illnesses, chronic diseases, smoking habit, drinking habits, and any additional information required for providing lifestyle management appropriate to each individual user's characteristics. The user data may also include sensor data that is acquired by at least one sensor. The sensor may be embedded in the mobile terminal, or may be an external electronic, electromechanical, or biomechanical hardware device that is wired or wireless connected to the mobile terminal and can transmit and receive data to and from the mobile terminal.

Referring to FIG. 2, the sensor may include such as, for example, an accelerometer, a GPS sensor, a microphone, a luminance sensor, a camera, a proximity sensor, a touch panel, an operating system (OS), and any type of biosensor. The sensors listed above are provided as examples, and the sensor may include any type of sensor that is capable of transmitting and receiving data to and from the mobile terminal and is wired or wireles sly connected to the mobile terminal.

As shown in FIG. 2, the sensor may acquire data about the user's activities, such as walking, running, driving, sleeping, and the like; data about the user's state, such as a user's current location, and the like; data about a user's voice, such as a user's tone of speaking, volume of voice, and the like; data about the user' surroundings, such as whether the user is indoors or outdoors and whether it is daytime or nighttime, and the like; data about a current call status in association with the location of the mobile terminal; data about the user's activity on a touch panel; data about the user's software usage history; and the user's biometric data, such as blood-sugar levels and blood-pressure measured by a biosensor. The data acquired by the sensors may also include the user's other physical activity data, such as, for example, the user's travel, meals, and the like.

The sensors may also acquire emotional data, such as, for example, programs and applications frequently used by the user; the user's frequent telephone, text, and e-mail contacts; and frequency and type of social network services used by the user. The user's lifestyle may be managed by taking into account all types of data collected by the sensors.

The determining unit 120 may analyze the user data acquired by the collecting unit 110 based on a pre-established model, and determine whether a subsequent action is required. For example, the determining unit 120 may determine whether it is required to provide further information to the user.

Various examples of the model according to predetermined criteria including individual users' characteristics and characteristics of groups of similar users are illustrated in FIGS. 3A and 3B. As shown in FIG. 3A, a model may be established based on characteristics, such as, for example, sex, residence, age, occupation, location, smoking and drinking habits etc. of groups of similar users. The group of similar users may be classified based on normal users, users with diabetes, users with hypertension, etc. In another example, illustrated in FIG. 3B, the model may be established based on daily routine patterns of each similar group of users. In addition, the model may be established based on some behavioral characteristics of a similar group related to a particular target group. As such, the criteria for establishing a model may vary with the purpose and needs of the model establishment.

The determining unit 120 may determine the occurrence of an abnormal condition by comparing and analyzing data similarities between data acquired from the user and the similarity of a measure previously established in a model for a similar group of users. Here, the similarity measure may be any of distance-based similarity measure, such as Euclidean distance, cosine distance, multidimensional scaling (MDS), and the like, or a feature-based similarity measure, or a probabilistic similarity measure. In addition to the similarity measures, the determining unit 120 may determine the occurrence of abnormal condition using stochastic/statistical methods.

In response to the determining unit 120 determining the occurrence of abnormal condition, an information providing unit 140 may provide the user with information regarding the abnormal condition. For example, if a result of comparison between acquired data about the user corresponding to model 1 shown in FIG. 3A and the previously established model is determined to be similar to model 4, i.e., an average model of a patient with diabetes, it may be inferred that the user's blood-sugar level may have increased and the user has a risk of developing diabetes. In this case, the information providing unit 140 may provide the user with information regarding the user's elevated risk of diabetes and some strategies for minimizing the health risk. For example, on determining that the user has an elevated risk of diabetes, the information providing unit 140 may warn the user about a risk of diabetes and provide information about the user's blood-sugar level measurement results, pulse measurement result, diabetes-related information, such as, for example, recommended meal portions, foods to avoid, common knowledge about diabetes, etc.

The determining unit 120 may also compare the acquired user data with the model to determine whether the acquired data needs to be learned or analyzed by a server 20 or it should be analyzed and determined based on a model previously established in the server 20. For example, if the acquired user data does not match with any established model, the determining unit 120 may determine that the acquired data is meaningful data of a new type, i.e., the acquired data needs to be learned and analyzed by the server 20.

In addition, the apparatus 100 may further include a transmitting unit 150 to transmit the acquired user data to the server 20 in response to the determining unit 120 making a determination that the acquired data is such that the server 20 needs to learn and analyze it.

When data is transmitted to the server 20 by the transmitting unit 150, the determining unit 120 may maximize the utilization of resources on the mobile terminal by avoiding unnecessary power consumption. The determining unit 120 may adjust the user data collection interval or the data transmission interval. In the alternative, the user data collection interval or the data transmission interval may be set in advance or may be adjusted later by the user. In another example, the criteria for adjusting the data collection interval or the data transmission interval may be predefined.

For example, the user may set the data collection interval to one hour, two hours, twice a week, once a month, and the like. In addition, the data transmission interval may be set to each time when meaningful data that needs to be transmitted to the server is generated, once a day, once a week, once a month, or the like. Furthermore, if the likelihood of occurrence of an abnormal condition or meaningful data is small, the user may set the data collection interval or the data transmission interval long, and thereby, minimize the waste of resources resulting from the unnecessary frequent data collection or transmission. Moreover, if the abnormal conditions or the meaningful data required to be transmitted to the server occur more than a predetermined number of times, the user may shorten the data collection interval or the data transmission interval.

Further, the apparatus 100 may include an interval controlling unit 160 to adjust an interval of collection or transmission in response to the determining unit 120 making a determination that the interval adjustment is needed based on the predetermined criteria.

The user may set or adjust the data collection interval, as described above, based on the user's current state of health, emotional state, and the like, and also adjust the data transmission interval depending on the state of the user's terminal, to accurately and efficiently manage the user's daily activities.

In a further example, the apparatus 100 may further include a storage unit 130 and an updating unit 170. The storage unit 130 may store the models transmitted from the server 20 via the updating unit 170. In addition, the storage unit 130 may store the data collection interval, data transmission interval, and information about various references, such as adjustment reference and information that are to be provided to a user. The collecting unit 110, the determining unit 120, the information providing unit 140, the transmitting unit 150, and the interval controlling unit 160 may use the data present in the storage unit 130.

In addition, the updating unit 170 may issue a request to the server 20 at regular intervals to check on the availability of an updated model. If an updated model is present, the updating unit 170 may receive the updated model from the server 20 and may update the storage unit 130 with the received model.

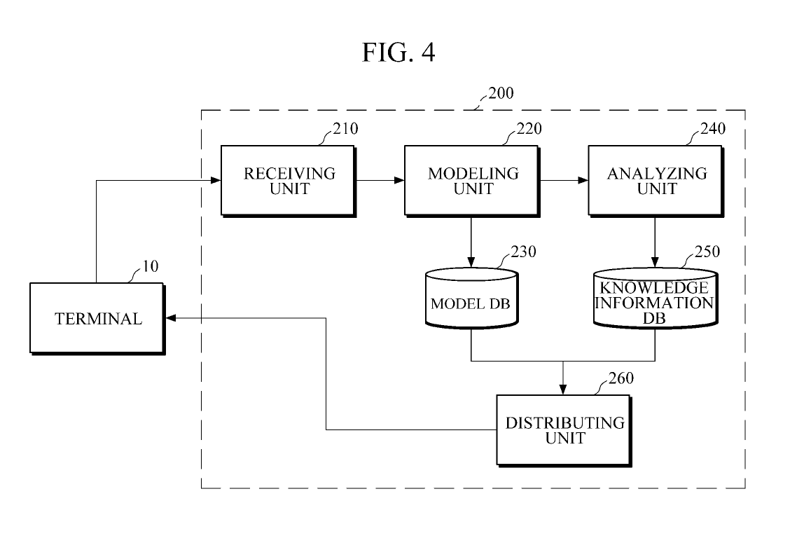

FIG. 4 is a diagram illustrating an example of an apparatus for lifestyle management based on a model. Referring to FIG. 4, the apparatus 200 for lifestyle management based on a model may be installed on a server. The apparatus 200 may include a receiving unit 210, a modeling unit 220, a model database 230, an analyzing unit 240, a knowledge information database 250, and a distributing unit 260.

The receiving unit 210 receives user data from terminal 10. The user data received from the terminal 10 may be a new type of data that is to be determined based on comparative analysis with a model previously stored in the terminal 10.

The modeling unit 220 may learn and analyze the received user data, and establish a model using the learned and analyzed user data according to predefined criteria including individual users' characteristics or characteristics of a group of similar users. Then, the modeling unit 220 may store the established model in the model database 230. The predefined criteria may be specified in various ways depending on the purpose and/or need of establishing a model. For example, the model may be established based on an individual users' characteristics, such as, for example, sex, age, occupation, residence, workplace, current illnesses, chronic diseases, smoking habit, drinking habit, and the like. The model may also be established based on characteristics of a group of similar users, such as, for example, normal people, patients with diabetes, patients with hypertension, characteristics of a group that is not similar but related to a particular group, or the like. Before establishing a new model, the modeling unit 220 may compare the received data with the existing models in the model database 230 to determine whether a matched model is present. This is because the received data may match with a model that has been established based on data previously received from another user's terminal.

The analyzing unit 240 may analyze the learned data or the established model to create new knowledge or information. For example, if the analysis shows a new type of medical data that is different from the existing data type, the analyzing unit 240 may provide the new data to medical experts such that they can utilize the new data for research. If new knowledge or information is discovered, the analyzing unit 240 may receive the new information to store and manage it in the knowledge information database 250, thereby allowing the user to utilize the new information.

The distributing unit 260 may provide the terminal 10 with a newly established model that is created by the modeling unit 220. The distributing unit 260 may check, at regular intervals or on request by terminals 10, whether the model database 230 has been updated with a new model, and if there is an updated model, the distributing unit 260 may transmit the new model to the terminals 10. The distributing unit 260 may transmit models to the corresponding terminals 10 by extracting the models associated with characteristics of users of the respective terminals 10 from among a plurality of models present in the model database 230. In addition, the distributing unit 260 may provide the terminal 10 with new knowledge or information created or received by the analyzing unit 240. The terminal 10 may provide the received knowledge or information to the user.

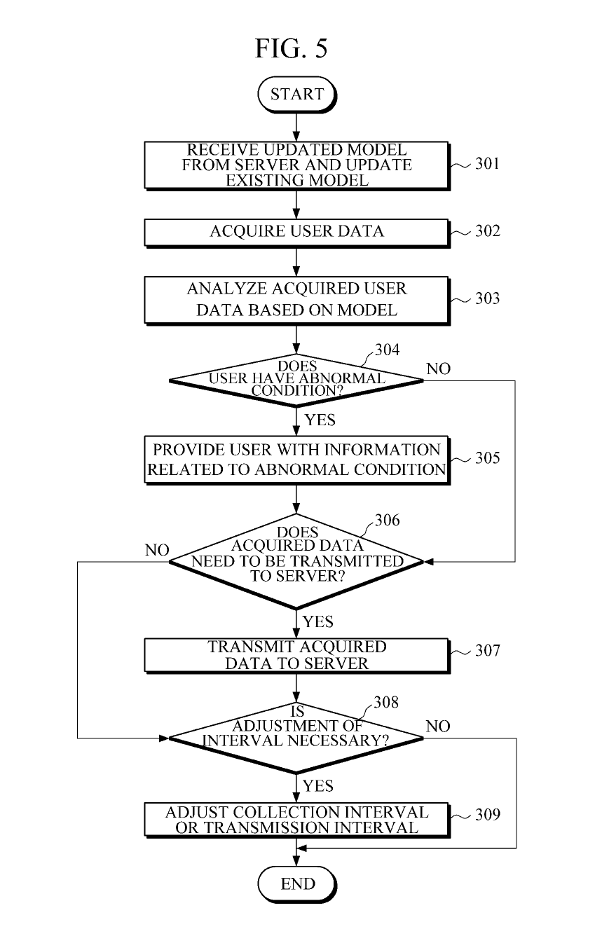

FIG. 5 is a diagram illustrating an example of a method of lifestyle management based on a model. The method shown in FIG. 5 may be implemented by the lifestyle management apparatus 100 shown in FIG. 1. The operations in FIG. 5 may be performed in the sequence and manner as shown, although the order of some operations and the like may be changed without departing from the spirit and scope of the illustrative examples described.

In 301, the lifestyle management apparatus 100 may check the server 20 to request whether there is an updated model, and if the updated model is present, the lifestyle management apparatus 100 may receive the updated model from the server 20 and update the existing model to the new model.

As described above, the lifestyle management apparatus 100 may acquire user data and sensor data obtained by one or more sensors in 302. The user data may be used to estimate an average characteristic model of similar users. In 303, the user data acquired in 302 is compared to a model and analyzed. The analysis may be performed by comparing data similarities between acquired user data and the previously established model by use of any similarity measure described above. In addition to the similarity measures, the occurrence of abnormal condition may be determined by use of stochastic/statistical methods.

Thereafter, in 304, it is determined whether a user has an abnormality, and if the user has an abnormality, information about the abnormality is provided to the user in 305. For example, if the result of the analysis shows that the model based on the user's information is different than the average model of other users with similar characteristics, a determination may be made that the user has an abnormality. As described above, if analysis of a model based on information of a user corresponding to model 1 shown in FIG. 3A discloses that the user's model is similar to model 4, the user may be suspected to be diabetic. In this case, the user may be provided with a measurement of a blood-sugar level, a measurement of pulse rate and diabetes-related information (for example, food to be avoided, recommended meal portions, common knowledge about diabetes, etc.). Information about each abnormality to be provided to users may be stored in advance.

In 306, it is determined whether or not the acquired data needs to be transmitted to the server 20. In other words, whether or not the data is required to be learned or analyzed by the server 20 or to be compared with a previously established model in 306. In 307, the data is transmitted to the server 20, when the data is determined to be meaningful enough. If, as a result of the analysis, it is determined that there is no similar model to the acquired data, it may indicate that the data is a new type of meaningful data, so the data may be transmitted to the server 20 such that the server 20 can learn and analyze the data to establish a new model or to discover new knowledge or information.

In an additional aspect, in 308, it is determined, based on the analysis result, whether or not data collection interval or data transmission interval needs to be adjusted., In 309, in response to the determination being made that the adjustment is required, the data collection interval or the data transmission interval is changed. As described above, the user may previously define a cycle or interval suitable to the user's current condition (for example, the current health status, resource conditions of a user's terminal, etc.) or create criteria for adjusting a cycle or interval in the occurrence of an abnormal condition, and may be able to control the cycle or interval based on any such criteria. If abnormal conditions occur frequently, the user may collect data more often to monitor such conditions more carefully. Operations following operation 301 may be repeatedly performed at preset or adjusted intervals.

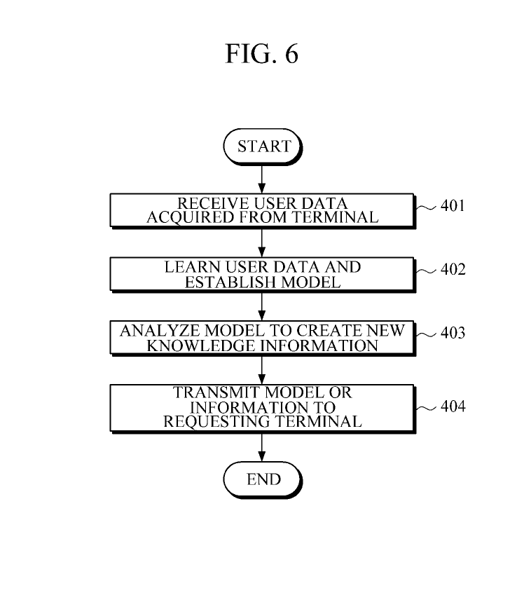

FIG. 6 is a diagram illustrating an example of a method of lifestyle management based on a model. The method of managing a user's lifestyle may be implemented by the model-based lifestyle management apparatus 200 shown in FIG. 4. The operations in FIG. 6 may be performed in the sequence and manner as shown, although the order of some operations and the like may be changed without departing from the spirit and scope of the illustrative examples described.

In 401, the lifestyle management apparatus 200 receives user data from terminal 10. The apparatus 200 may receive the user data at predefined intervals depending on state of the resources of the terminal 10. In addition to the user data acquired by the terminal 10, other types of data may also be provided to the apparatus 200.

In 402, the apparatus 200 learns and analyzes the received data, establishes a model based on the learned and analyzed data according to criteria including characteristics of individual users or groups of similar users, and stores the established model in the model database 230. In this operation, the received user data may be analyzed by being compared with models present in the model database 230 to determine whether or not the model database 230 stores a model matching the received data.

In 403, new knowledge or information may be created based on the analysis of the learned data or the established model. In addition, result of the analysis of the learned data or established model is provided to experts such that the experts can utilize the result as raw data to discover new knowledge or information, and the apparatus 200 may receive and manage new knowledge or information discovered by the experts.

In 404, a newly established model or new knowledge or information is provided to terminal 10. The newly updated model or the knowledge or information may be transmitted at predefined intervals and on request by a terminal 10. Models associated with the characteristics of the respective users or groups of similar users of each terminal may be extracted and transmitted to the corresponding terminals 10.

The units and apparatuses described herein may be implemented using hardware components. The hardware components may include, for example, controllers, sensors, processors, generators, drivers, and other equivalent electronic components. The hardware components may be implemented using one or more general-purpose or special purpose computers, such as, for example, a processor, a controller and an arithmetic logic unit, a digital signal processor, a microcomputer, a field programmable array, a programmable logic unit, a microprocessor or any other device capable of responding to and executing instructions in a defined manner. The hardware components may run an operating system (OS) and one or more software applications that run on the OS. The hardware components also may access, store, manipulate, process, and create data in response to execution of the software. For purpose of simplicity, the description of a processing device is used as singular; however, one skilled in the art will appreciated that a processing device may include multiple processing elements and multiple types of processing elements. For example, a hardware component may include multiple processors or a processor and a controller. In addition, different processing configurations are possible, such a parallel processors.

A number of examples have been described above. Nevertheless, it will be understood that various modifications may be made. For example, suitable results may be achieved if the described techniques are performed in a different order and/or if components in a described system, architecture, device, or circuit are combined in a different manner and/or replaced or supplemented by other components or their equivalents. Accordingly, other implementations are within the scope of the following claims.

What is claimed is:

1. An apparatus for lifestyle management, the apparatus comprising:
a collector configured to acquire user data including data acquired by a sensor;
a determiner configured to analyze the acquired user data based on a model and determine whether a user has an abnormal condition; and
an information provider configured to provide the user with information of the abnormal condition.

2. The apparatus of claim 1, wherein the model is created according to criteria including characteristics of individual users or groups of similar users.

3. The apparatus of claim 2, further comprising an updater configured to receive models from a server.

4. The apparatus of claim 1, wherein the sensor data includes at least one of user's activities, user's state, user's voice, user's surroundings, user's activity on a touch panel, user's terminal's location, user's terminal's call status, user's software usage history, user's emotional data, and user's biometric data.

5. The apparatus of claim 4, wherein the user data comprises at least one of user sex, age, occupation, residence, workplace, current illnesses, chronic diseases, smoking habit and drinking habit.

6. The apparatus of claim 1, wherein
the determiner is further configured to determine whether the acquired user data is required for a server to learn; and
the apparatus further comprises a transmitter configured to transmit the acquired user data to the server.

7. The apparatus of claim 6, wherein
the determiner is further configured to determine whether to adjust a user data collection interval or a data transmission interval for transmitting data to the server; and
the apparatus further comprises an interval controller configured to adjust the user data collection interval or the data transmission interval according to predefined criteria.

8. An apparatus for lifestyle management, the apparatus comprising:
a receiver configured to receive user data from terminals;
a modeler configured to create one or more models from the received user data and according to predefined criteria including characteristics of individual users or groups of similar users;
an analyzer configured to analyze the one or more models and create new information; and
a distributor configured to transmit the one or more models or new information to a requesting terminal.

9. The apparatus of claim 8, wherein the distributor is further configured to selectively transmit the one or more models associated with characteristics of a user of the requesting terminal.

10. A method of lifestyle management, the method comprising:
acquiring user data including sensor data generated by a sensor;
analyzing the acquired user data based on a model;
determining whether a user has an abnormal condition; and
providing the user with information of the abnormal condition.

11. The method of claim 10, wherein the model is created based on criteria including characteristics of individual users or groups of similar users.

12. The method of claim 11, further comprising receiving a newly updated model from a server.

13. The method of claim 10, wherein the sensor data includes at least one of user's activities, user's state, user's voice, user's surroundings, user's activity on a touch panel, user's terminal's location, user's terminal's call status, user's software usage history, user's emotional data, and user's biometric data.

14. The method of claim 13, wherein the user data contains user's information including at least one of sex, age, occupation, residence, workplace, current illnesses, chronic diseases, smoking habit and drinking habit.

15. The method of claim 10, further comprising:
determining whether the acquired user data is required for the server to learn; and
transmitting the acquired user data to the server.

16. The method of claim 15, further comprising:
determining whether to adjust a user data collection interval or a data transmission interval for transmitting data to the server; and
adjusting the user data collection interval or the data transmission interval according to predefined criteria.

17. A method of lifestyle management, the method comprising:
receiving data acquired from terminals;
creating one or more models from the received user data and according to predefined criteria including characteristics of individual users or groups of similar users;
analyzing the one or more models to create new information; and
transmitting the one or more models or new information to a requesting terminal.

18. The method of claim 17, wherein transmitting the one or more models comprises selectively transmitting the one or more models associated with characteristics of a user of the requesting terminal to the requesting terminal.

19. The apparatus of claim 3, further comprising a storage database configured to store models at a terminal.

20. The apparatus of claim 8, further comprising:
a model database configured to store the models; and
a knowledge information database configured to store new information.
